(19) United States
(12) Patent Application Publication
(10) Pub. No.: US 2004/0267694 A1
(43) Pub. Date: Dec. 30, 2004

(54) Machine-readable medium & data management system and method for tracking real-world objects

(76) Inventors: Satoshi Sakai, Newport Coast, CA (US); Kalev Kask, Lake Forest, CA (US)

Correspondence Address: CONNORS ASSOCIATES, 1600 DOVE ST, SUITE 220, NEWPORT BEACH, CA, 92660

(21) Appl. No.: 10/610,352

(22) Filed: Jun. 30, 2003

(51) Int. Cl. G06F 7/00

(52) U.S. Cl. 707/1

(57) ABSTRACT

Disclosed is a machine-readable medium for programming a computer that is a component of a computer network. The machine-readable medium includes a processor executable instruction for enabling a user to access over the computer network a dynamic web page with hierarchically arranged data representing information corresponding to the status of real world objects.

The following words and phrases have the following definitions:

“comprising,” “having,” and “including,” and other forms thereof, are intended to be equivalent in meaning and be open ended in that an item or items following any one of these words is not meant to be an exhaustive listing of such item or items, or meant to be limited to only the listed item or items.

“machine-readable medium” means any device or media for retaining electronic information used by a computer and may include, but is not limited to, storage medium such as, for example, disk hard drives, floppy disk, dvd's, carrier waves that may take the form of electrical, electromagnetic or optical signals conveying digital data streams along a local area network or a public wide area network such as the “Internet,” or a remote computer to a requesting computer by way of data signals embodied in a carrier wave or other propagation medium via a communication link (e.g., a modem or network connection).

“real world object” means any physical object or collection of data or information and may include, but is not limited to, databases, software programs, chemicals, electronic and electrical devices, mechanical devices, and living being such as animals, plants and people.

“web page” means any electronic document suitable for visual display on a screen and may include for example, but is not limited to, a document on the World Wide Web, consisting of an HTML file and any related files for scripts and graphics, and often hyperlinked to other documents on the World Wide Web

### BACKGROUND OF INVENTION

Hierarchical tree structures have become a popular data manipulation tool often used in modern computer graphical operating systems such as UNIX, Windows 95, and Mac OSX, and equivalent graphical operating systems. Often these operating systems are designed to reduce data complexity by structuring data in hierarchical data sets and allowing the user to choose which portion of a data set is visible through expanding and collapsing controls.

Computer programs are commonly referred to as “software,” a term used to identify instructions used in a computer. This “software” is contained in a storage medium, which may include, but is not limited to, floppy diskettes, optical disks, CD-ROMs, and magneto-optical disks, ROMs, RAMs, EPROMs, EEPROMs, magnet or optical cards, flash memory, or other types of machine-readable medium suitable for storing electronic instructions. All these “software” formats are machine-readable mediums including processor executable instructions.

Computer networks typically include at least two computers connected together to communicate and transfer data between them, sometimes through a hub computer commonly referred to as a server. These networks may be wide area or local area computer networks. The global computer network commonly referred to as the “internet,” or the “world wide web,” is an example of a wide area computer network. Many businesses use private, local area computer networks, commonly referred to as “intranets,” for enabling employees to communicate with each other and with customers, vendors, managers, etc., and to access and track operations and information such as, for example, accounting records, machine operations, employee attendance, raw material, work in process, inventory, product sales etc.

A computer operating system may include a graphical user interface (GUI) that enables a user to display for viewing on a monitor screen data typically represented as icons. A browser may be used to navigate a computer network and locate web sites that have “web pages” displaying data on the user's monitor screen. These web pages may or may not be arranged in a hierarchical tree structure. Ordinarily they are static, rather than dynamic, and the data is not updated continuously and rearranged in a hierarchical tree structure as the information the data represents changes over time.

### SUMMARY OF INVENTION

This invention has one or more features as discussed subsequently. After reading the following section entitled “DETAILED DESCRIPTION OF SOME EMBODIMENTS OF THIS INVENTION,” one will understand how the features of this invention provide its benefits, which include, but are not limited to, providing:

(1) a software program that enables a user to access over a computer network a dynamic web page with hierarchically arranged data representing information of the status of real world objects where the data is updated on line,

(2) a software program that enables a user to create a hierarchical tree structure of virtual objects relating to real world objects in a configuration of his or her choosing,

(3) a software program that enables a user to create a web page that may be accessed in different languages and with a variety of different types of access devices,

(4) a software program that enables a user to customize what events will initiate actions, what actions are initiated, and whom to notify when selected events occur and the manner in which notification is given.

This invention comprises a data management system including a computer network, a machine-readable medium with instructions for programming a computer that is a component of the computer network, and a method for tracking over the computer network real-world objects that change status. The instructions constitute a program for enabling a user to create and access over the computer network a dynamic web page of icons arranged in a hierarchical tree structure. At least some of these icons represent data relating to the current status of real world objects. This data is updated on line over the computer network so that, upon being accessed, the most current data is provided.

Without limiting the scope of this invention as expressed by the claims that follow, some, but not necessarily all, of its features are:

One, the data management system of this invention includes a status monitor that monitors real world objects being tracked and communicates to a computer in the computer network data indicating the status of each monitored real world object. The computer network may be accessible with an access device operated by a user from a remote location. This computer includes a memory and processor programmed with a program transferred to the memory from the machine-readable medium of this invention.

Two, the data management system may include a node assignor, an object engine, a data receiver, and a graphical engine. The node assignor associates each real world object with one of a plurality of nodes in a hierarchical tree structure. The object engine creates a virtual object for each node in the hierarchical tree structure and places each virtual object in the hierarchical tree structure. The data receiver is adapted to receive data from each real-world object and associates this data with a virtual object corresponding to each real-world object. The graphical engine associates an icon with each of the virtual objects and visually displays the hierarchical tree structure as an arrangement of icons on a web page of the computer network.

Three, the program on the machine-readable medium of this invention includes a processor executable instruction for enabling a user to access over the computer network the dynamic web page displaying the hierarchically arranged icons that correspond to current status of the real world objects. This data is updated on line through the computer network to maintain its current status. The program may enable a user to create the hierarchical tree structure in a configuration of his or her choosing. It may also enable a user to customize select events that initiate action, what actions to initiate, and who to notify when selected events occur and the manner in which notification is given. It may also enable a user to create a web page that may be accessed in different languages and with a variety of different type of access devices.

Four, the program on the machine-readable medium of this invention may include one or more of the following processor executable instructions:

(a) an instruction for creating a user-definable hierarchical tree structure of virtual objects relating to one or more real-world objects including (i) at least one user-definable virtual object relating to a change in status in a related real-world object, and (ii) at least one user-definable virtual object that enables an authorized subscriber to access the hierarchical tree structure and communicate therewith to receive notification of a change in status in the real-world object;

(b) an instruction for creating a browser control object that enables a user to interface with the hierarchical tree structure and communicate with virtual objects;

(c) an instruction for creating a database capable of storing data relating to anyone of the virtual objects;

(d) an instruction for detecting the location in the hierarchical tree structure of any virtual object and changing the location in the tree structure of any one virtual object in response to notification of a change in status of a real word object related to the one virtual object.

(e) an instruction for interacting with a graphic user interface that enables the hierarchical tree structure to be displayed visually as an arrangement of parent and child nodes.

(f) an instruction for associating first status data with a virtual object to define the hierarchical relationship in the tree structure between one parent node and one child node based on the first data, and an instruction for associating second status data with the one child node and rearranging the one child node within the hierarchical tree structure under another parent node based on the second data.

(g) an instruction for identifying which of number of different human languages is being used by a human user and using the human language in visually displaying the hierarchical tree structure.

(h) an instruction for identifying which of number of different browser access devices is being used by a human user to interact with the hierarchical tree structure and to enable the browser control object to interface with the browser access device being used by the human user.

(i) an instruction for associating at least some of the nodes of the hierarchical tree structure with a web page that is opened through the browser control object interacting with a browser for the network.

(j) an instruction for (i) interacting with more than one access device for accessing the hierarchical tree structure over the network, (ii) identifying the type of access device being used, and (iii) formatting the visual display of the hierarchical tree structure based on the type of access device being used;

(k) an instruction for enabling each virtual object to be capable of communicating with another virtual object.

Five, these instructions facilitate several operations including the arrangement of current status data for each real world object as virtual world objects organized in a hierarchical tree structure including parent and child nodes. The hierarchical tree structure is visually displayed through the computer network as a web page that may be opened from a remote location using one or more access device. The instructions may enable a plurality of authorized subscribers to access the web page. The parent and child nodes may be rearranged as the status of any one of the real world objects changes. A database may be provided in which the status data of the real world objects is stored. Data indicating the current status of the real world object related to each node may be updated on line over the computer network. The nodes of the hierarchical tree structure being displayed on web page may be represented as interactive icons that upon being opened display the data corresponding to the current status of the related real world object.

This invention also includes methods for tracking over a computer network real-world objects that change status. These methods are described in the section entitled “DETAILED DESCRIPTION OF SOME EMBODIMENTS OF THIS INVENTION,” and summarized in the method claims that follow.

### DESCRIPTION OF DRAWING

Some embodiments of this invention, illustrating all its features, will now be discussed in detail. These embodiments depict the novel and non-obvious data management system, machine-readable medium, and method of this invention as shown in the accompanying drawing, which is for illustrative purposes only. This drawing includes the following figures (Figs.), with like numerals indicating like parts:

FIG. 1 is a schematic diagram of a data management system employing an embodiment of the machine-readable medium of this invention.

FIG. 1A is a flowchart describing the creation of a virtual object associated with a real world object.

FIG. 2 is a schematic diagram illustrating an embodiment of this invention where icons representing virtual objects related to real-world objects are displayed on a user's monitor screen as part of a graphical user interface (GUI).

FIG. 3 is a schematic block diagram of an embodiment of this invention illustrating the interaction of a data management system according to an embodiment of this invention with a real-world object and an output unit.

FIG. 4 is a data table provided using an embodiment of the machine-readable medium of this invention.

FIG. 5 is a graphical display of a command menu provided using an embodiment of the machine-readable medium of this invention.

FIG. 6A is a diagram of a region and geographical locations of police cars within that region at a first instance of time.

FIG. 6B is a graphical display of a hierarchical tree structure on a user's screen corresponding to the data depicted in FIG. 6A.

FIG. 7A is a diagram of the region shown in FIG. 6A showing the geographical locations of police cars within that region at a second instance of time.

FIG. 7B is a graphical display of a hierarchical tree structure on a user's screen corresponding to the data depicted in FIG. 7A.

FIG. 7C is a block diagram illustrating the interaction between a real-world object and a node assignor according to an embodiment of this invention.

FIG. 7D is a flowchart describing functions of the node assignor in FIG. 7C.

FIG. 8 is a diagram of an event messaging menu provided using an embodiment of the machine-readable medium of this invention.

FIG. 9A is schematic diagram illustrating an idle machine that is being monitored and a graphical user interface used with a data management system according to an embodiment of this invention depicting the monitoring function.

FIG. 9B is schematic diagram like that of FIG. 9A depicting a change in status of the machine illustrated in FIG. 9A changing status.

FIG. 10 is a schematic diagram illustrating virtual world objects exchanging data in a data management system according to an embodiment of this invention.

FIG. 11 is a block diagram illustrating interaction between an event virtual object with a subscriber virtual object and a real-world object according to an embodiment of this invention.

FIG. 12 is a diagram of a graphical user interface that displays the event virtual object described in FIG. 11

FIG. 12A is a flowchart describing the subscription and notification of an event message according to an embodiment of this invention.

### DETAILED DESCRIPTION OF SOME EMBODIMENTS OF THIS INVENTION

### General

One aspect of this invention is the organization of data in a dynamic hierarchical tree structure HTS where the data is continually updated over time, either continuously, intermittently in a random fashion, or periodically in a non-random fashion. Another aspect of this invention is that, via the hierarchical tree structure, a user may access data originating from real-world objects, communicate commands to the real-world objects, configure and receive event messages that are triggered by data received from the real-world objects, and enable individuals who are authorized as subscribers to communicate with each other and modify the functions of the collection and distribution of data. The data may, for example, originate from such real-world objects as databases, software programs, machines, white boards, video cameras, people, etc. The virtual objects forming a hierarchical tree structure HTS may be visually displayed as icons appearing on a monitor screen and arranged as parent and child nodes.

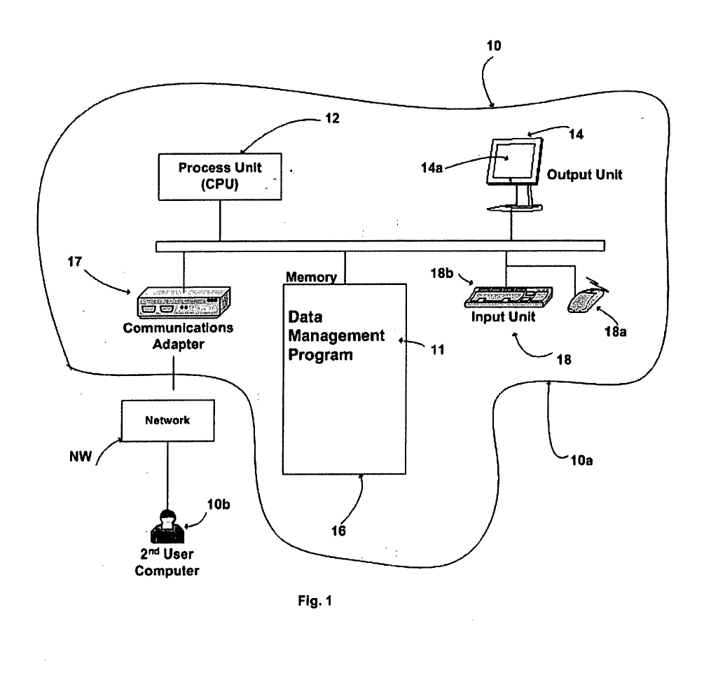

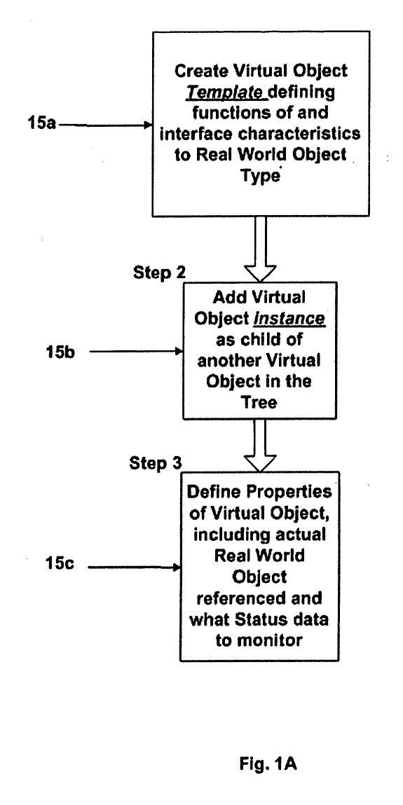

A hierarchical tree structure HTS is typically built by a user associating selected data with a virtual object. Data from physical things, an event, an authorized subscriber, control functions, etc. maybe associated with virtual objects. Referring to FIG. 1A, a virtual object template 15a may be created that defines the functions of and characteristics of virtual objects used to represent real world objects. Using the template 15a, a virtual object 15b may be added as a child of another virtual object in a hierarchical tree structure HTS. The properties 15c of the virtual object are defined by the user and may include a reference to an associated real world object and what data to monitor.

The user thus defines what data is associated with a virtual object, defines the commands a user may perform, defines the information to be visually displayed, defines the way the information is displayed, defines the icon used to represent a virtual object, and defines subscriber access rights. A user may define whether the data from a real-world object is queried intermittently or continuously, whether data is stored in a database for later retrieval and whether data is provided as streaming data. If a virtual object is associated with a real-world object over a wide area network such as the “Internet,” a user may define the internet protocol address of the real-world object. A user may place restrictions on what the nodes, parent or child, a virtual object may be associated with, using, for example, a routing table or a routing logic, or both. A user may choose to display data as a web page, such as, status information and associate this data with an icon generated by a graphical user interface operating in accordance with instructions carried by the machine-readable medium of this invention.

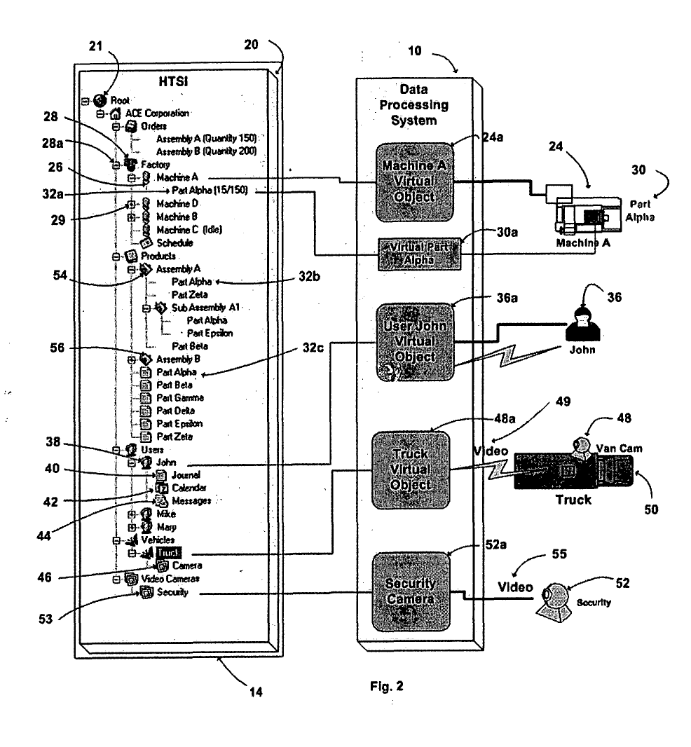

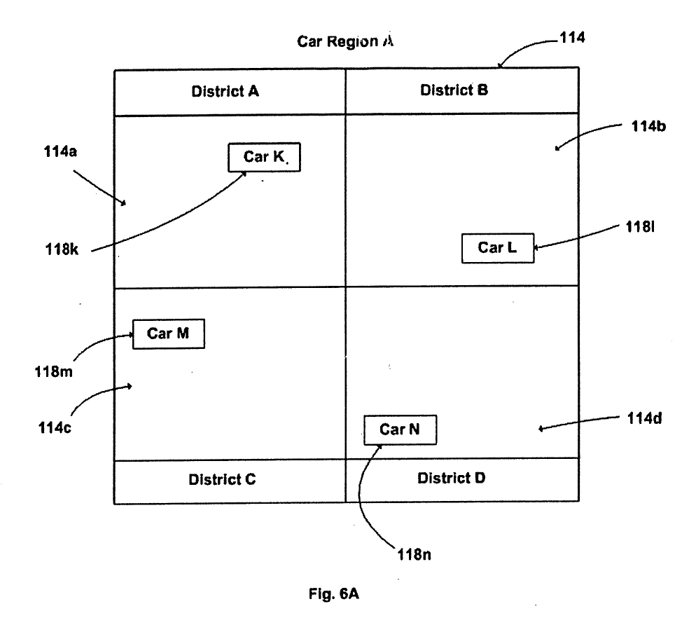

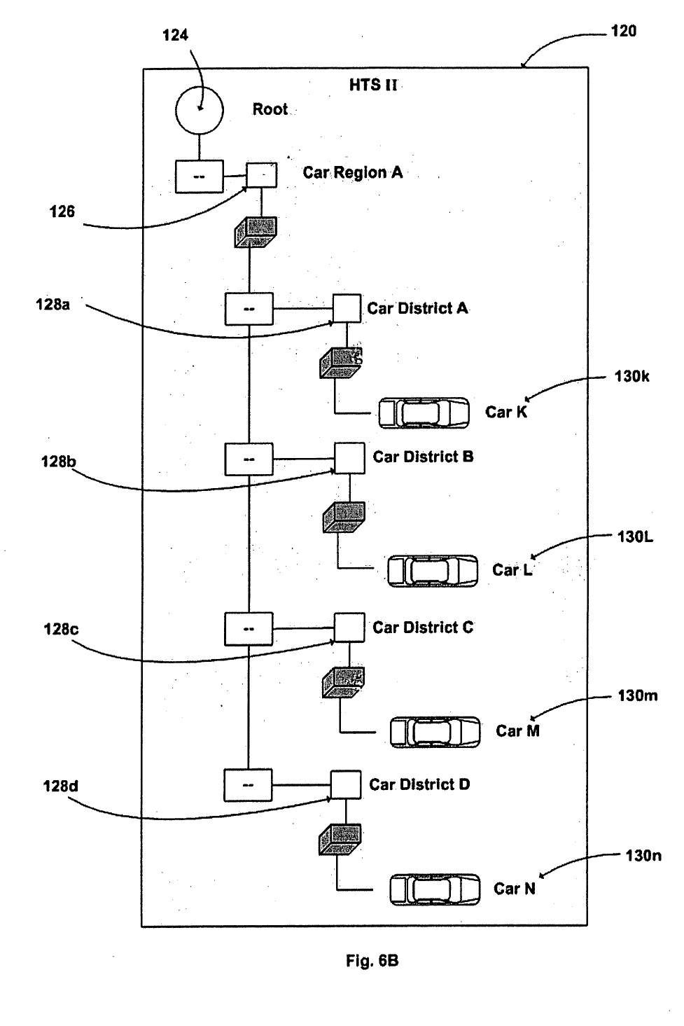

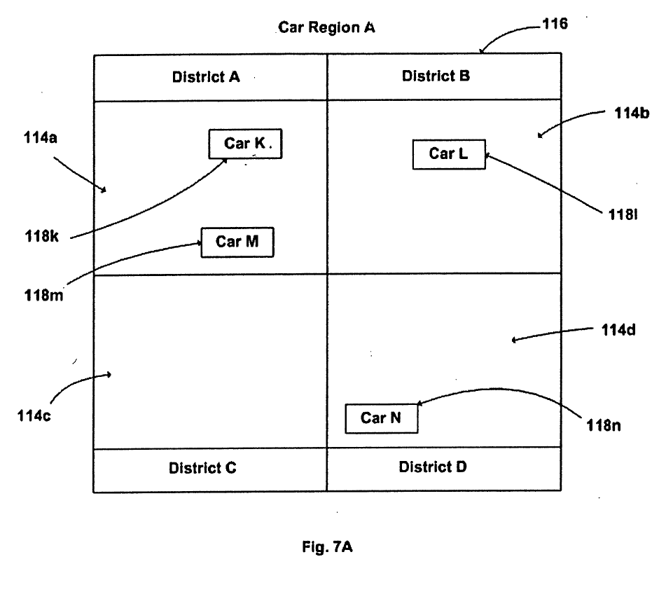

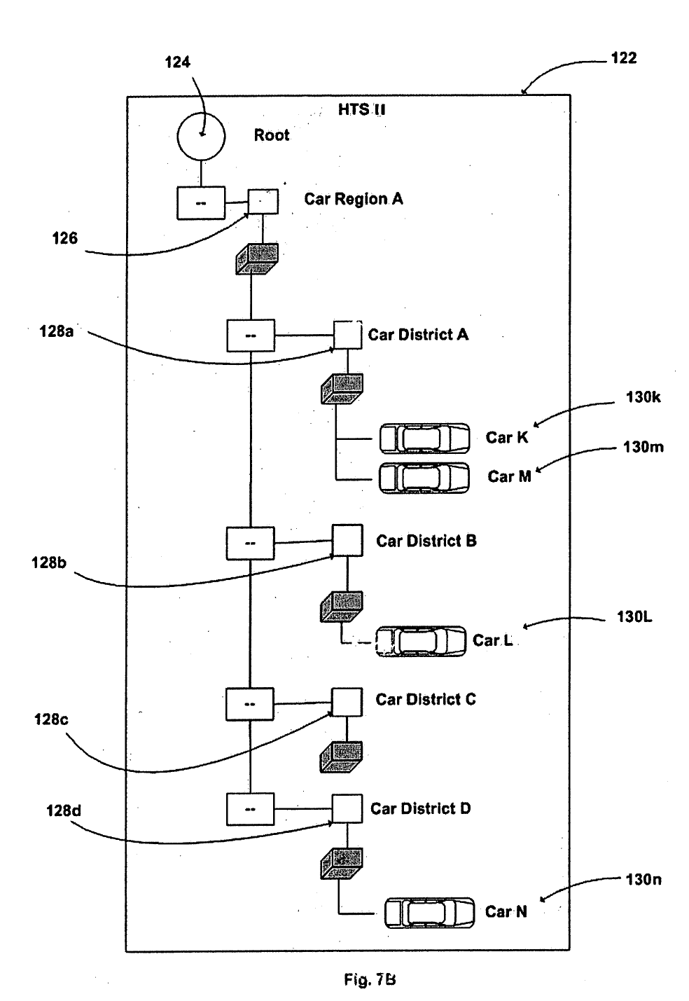

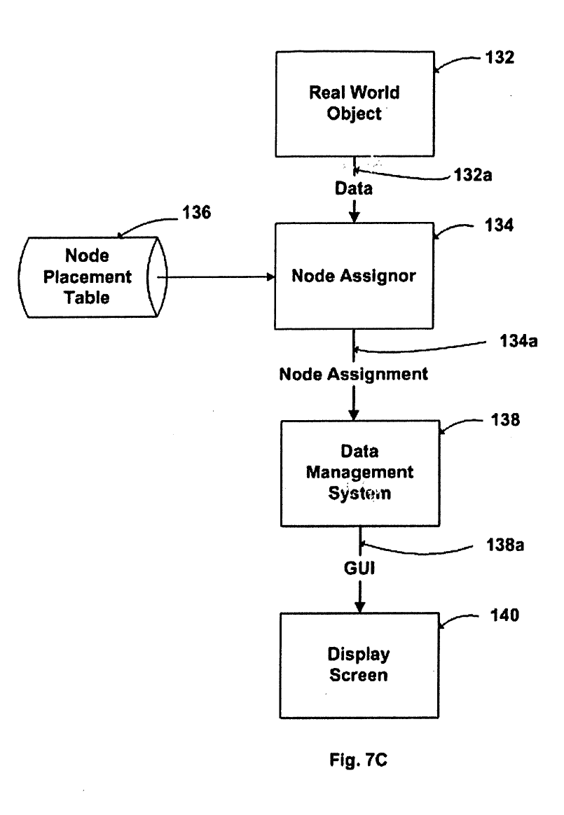

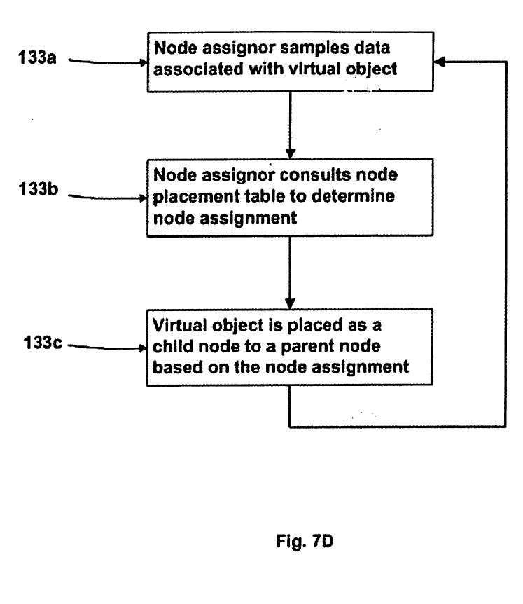

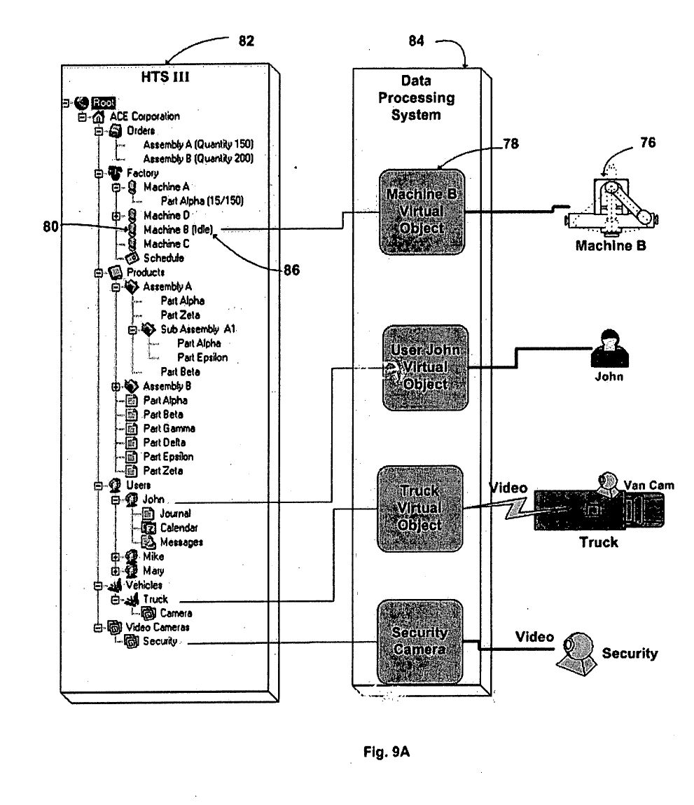

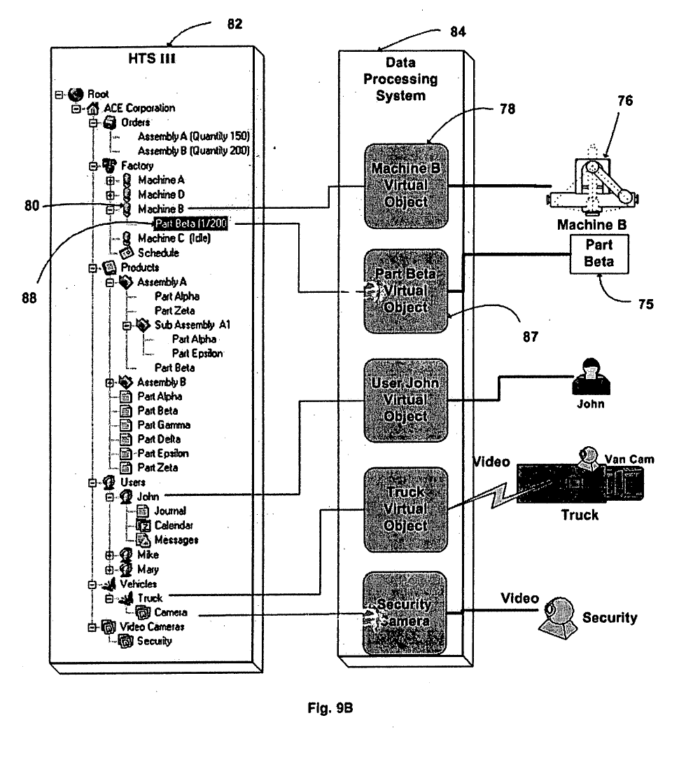

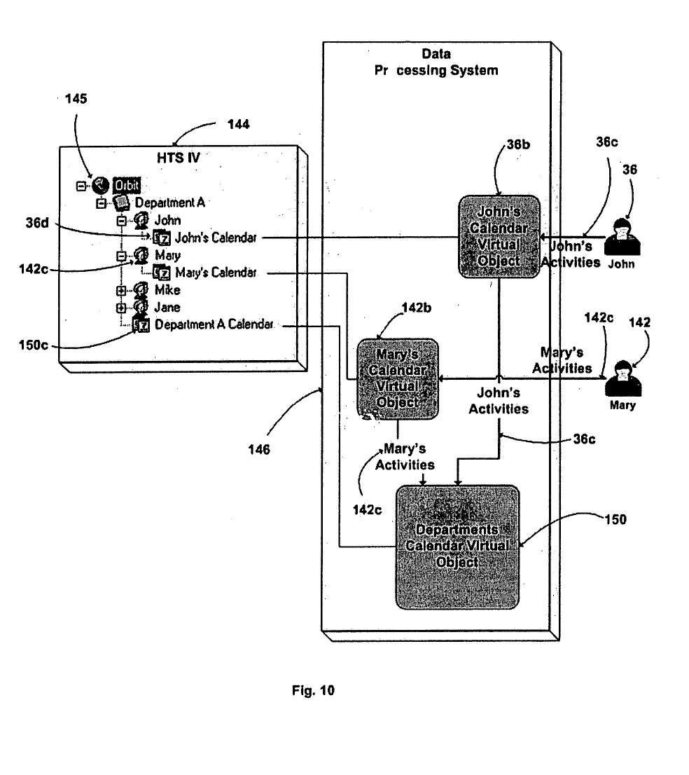

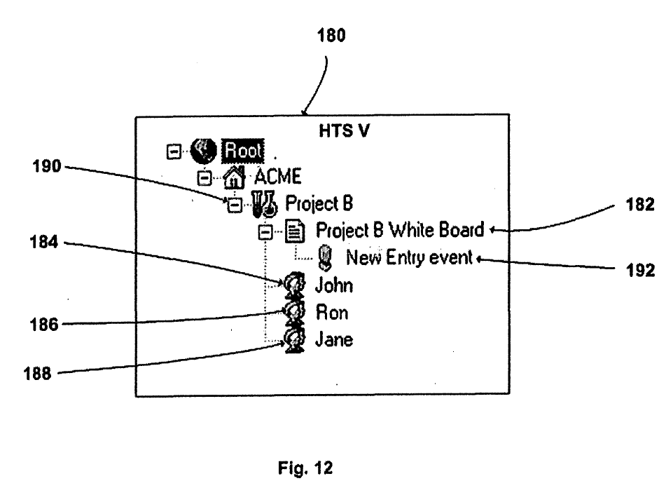

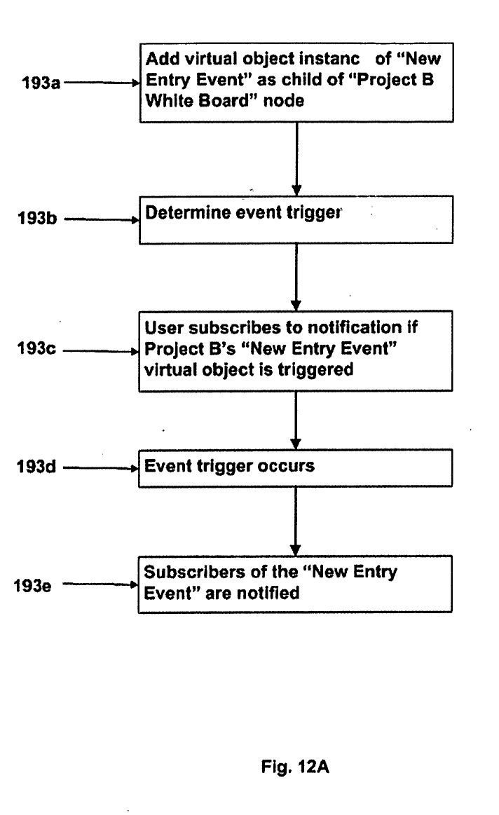

An aspect of this invention is that the user creates the arrangement of parent and child nodes of the hierarchical tree structure HTS in any fashioned desired. For example: FIG. 2 depicts a user-defined tree structure identified by the alphanumeric characters HTS I. FIGS. 6B and 7B depict a user-defined tree structure identified by the alphanumeric characters HTS II. FIGS. 9A and 9B depict a user-defined tree structure identified by the alphanumeric characters HTS III. FIG. 10 depicts a user-defined tree structure identified by the alphanumeric characters HTS IV. FIG. 12 depicts a user-defined tree structure identified by the alphanumeric characters HTS V.

### Data Management System

FIG. 1 illustrates a data management system 10 of this invention having a data management program 11 carried by the machine-readable medium of the present invention is installed therein. The data management system 10a includes a user's computer 10a that is connected to another computer 10b (or laptop, personal digital assistant (PDA) etc.) over a network NW. Multiple users may access the network NW in many ways, for example, over the Internet, by telephone through a voice recognition interface, and a personal digital assistant.

The data management system 10a includes a memory 16 into which the program 11 may be downloaded and stored, a central processor unit (CPU) 12 for processing data in accordance with the instructions in the program, an output unit 14, and an input unit 18. There is a communication adapter 17 that allows the computer 10a to communicate with the computer 10b over the network NW. The output unit 14 may comprise a monitor having a display screen 14a, and the input unit 18 may comprise a mouse 18a and keyboard 18b.

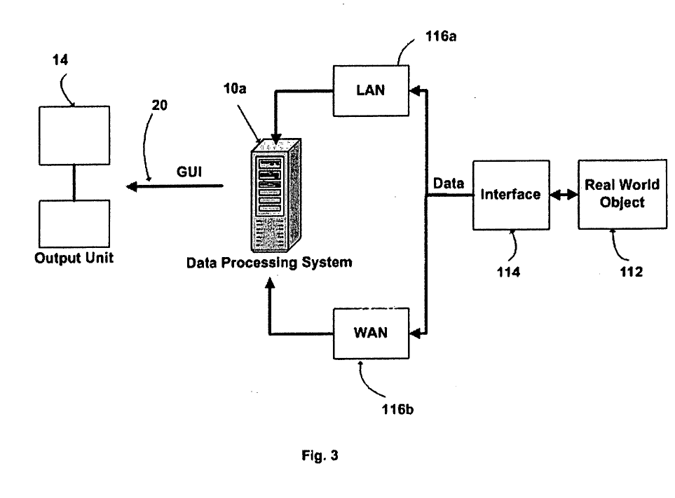

FIG. 3 illustrates establishing communication between a hierarchical tree structure HTS embedded in the program 11 and a real-world object 112 for transmitting data originating with the real-world object to the data management system 10 to update the virtual objects of the program. An interface 114 may connect to the real-world object 112 to collect data originating from this real-world object. A programmable logic controller may be used as the interface 112 to actuate and receive data from the real-world object 112. An example of a suitable programmable logic controller is the Multifunction EDAS constructed by Intelligent Instrumentation Inc. of Tucson, Ariz., USA. The Multifunction EDAS gathers data from the real-world object, for example, from machinery through instruments, such as, sensors, transducers and cameras. The interface 114 may communicate with the data management system 10 through a local area network (LAN) 116a or a wide area network (WAN) 116b. The data management system 10a is connected to the output unit 14, or the communications adapter 17 (FIG. 1), or both, to allow a user to interact therewith through a graphic user interface 20.

The instructions carried by the machine-readable medium of this invention may provide for accessing a virtual object-building menu for creating virtual objects by using the mouse 18a to click on a virtual object icon generated and displayed the monitor screen 14a. In creating a hierarchical tree structure HTS, a virtual object corresponds to data originating from a real-world object, an event object, and an authorized subscriber object, etc. The user organizes the virtual objects (and therefore the data associated with these virtual objects) as parent and child nodes in a hierarchical tree structure HTS. A user configuration file may be stored in the memory 11 with instruction for the visual display of data. This user configuration file may include instructions that define subscriber access rights, store a display configuration for the user, or contain other instructions. Subscriber access rights may include all rights, no rights, read only rights, write only rights, etc. The display configuration instructions may, for example, select a specific graphic user interface for use with the type of access device a user is using, and the user's language to access the data management system 10a. For example, a Japanese-speaking user may access the network NW through a PDA. The configuration file will have special instructions for displaying data for this user speaking this language and using a personal digital assistant. Thus, whenever this Japanese-speaking user accesses the data management system 10a, the data management system 138 accesses the user's configuration file and a specific graphic user interface is generated to display Japanese characters formatted for the resolution and color capabilities of the PDA. Another user's file may contain different instructions, for example, to display a graphical user interface with English characters formatted for the resolution and color capabilities of a laptop computer. Access to the system may be session based, allowing a user to access the data management system 10a simultaneously through multiple devices.

HTS I

FIG. 2 shows a graphical user interface 20 used in connection with the management of data from the real-world objects identified by the numerals 24, 30, 36, 48, 52. The graphical user interface 20 displays icons corresponding to in the hierarchical tree structure HTS I. The icons are arranged as parent and child nodes that may be accessed by pointing and clicking. Specifically, icons identified by the numerals 26, 32a, 38, 46, and 53, correspond to the virtual objects identified by the numerals 24a, 30a, 36a, 48a, and 52a, respectively. Each icon identified by the numerals 26, 28, 32a, 32b, 32c, 38, 40, 42, 44, 46, 53, 54, 56 corresponds to a node in the hierarchical tree structure HTS I. A parent node/icon having child nodes, for example, the “Factory” node/icon 28 may have a button 28a that is used to expand and collapse the view of the child nodes. A “−” in the button indicates that the view is expanded, while a “+” in the button indicates the view is collapsed, as shown in button 29.

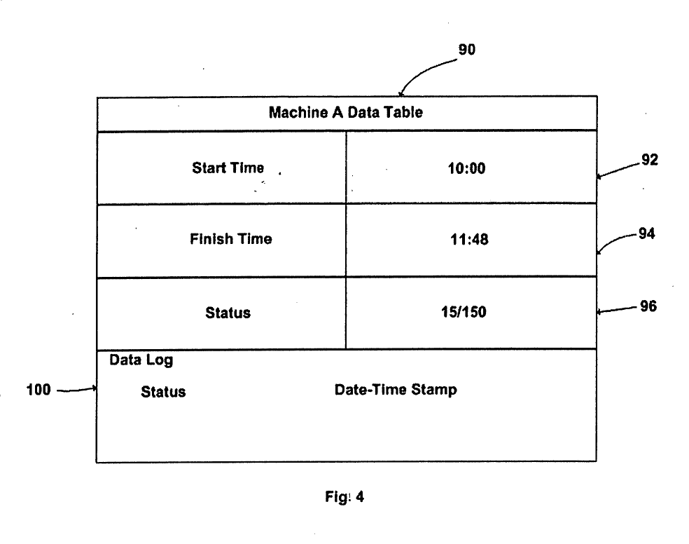

A user may access data associated with a virtual object in the hierarchical tree structure HTS I by clicking on the icon representing this virtual object. For example, clicking on the icon 26 opens up the Machine A Data Table 90 illustrated in FIG. 4. As shown in FIG. 2, a machine A identified by the numeral 24 is a real-world object that manufactures parts, such as part Alpha 30. Machine A 24 is represented by a “Machine A” virtual object 24a, and part Alpha 30 is represented by a “Part Alpha” virtual object 30a. The icon 26 represents the “Machine A” virtual object 24a, and the “Part Alpha” virtual object 30a is represented by the “Part Alpha” icon 32a. In the graphic user interface 20, the “Machine A” icon 26 is represented as a child of the “Factory” icon 28 because Machine A 24 is located in the factory, and part Alpha 30 is represented as a child of the “Machine A” icon 26 because machine A 24 is making part Alpha 30.

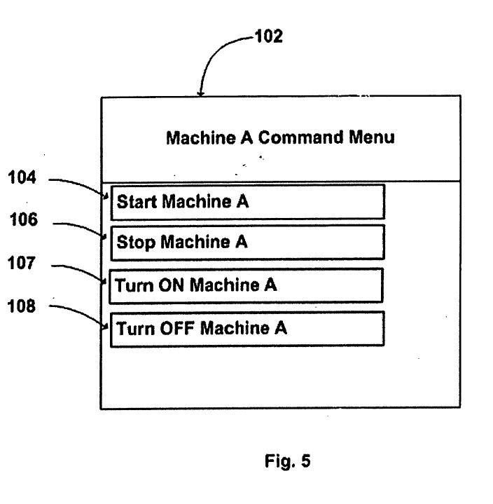

As depicted in FIG. 4, upon a user clicking the “Machine A” icon 26 to open up a Machine A Data Table 90, status information about Machine A is provided. For example, this displays the start time 92 of a currently manufactured part, projected finish time 94, current status of a production run 96, and data log 100 retaining a history regarding other parts that have been or will be manufactured. As shown in FIG. 5, the “Machine A” icon 26 may also be used to transmit data and/or commands to its corresponding real-world object Machine A 24. For example, clicking on the “Machine A” icon 26 may open up a menu 102 (FIG. 5) that provides command buttons that can include, but are not limited to, start Machine A button 104, stop Machine A button 106, turn on Machine A button 107, and turn off Machine A button 108. The data table 90 of FIG. 4, and the menu 102 of FIG. 5 may be displayed on the screen 14a as part of a web page. The program 11 may include instructions to create a browser control object that enables a user to interact with a network browser for navigating the network NW. For example, as shown in FIG. 2, John 36 is a real-world human being. Data from John 36 is associated with a virtual object 36a, and the icon “John” 38 represents this virtual object 36a. The “John” 38 virtual object functions as a browser control object that enables the user John 36 to interface with the hierarchical tree structure HTS I through the icons comprising an image of the hierarchical tree structure HTS. The “John” icon 38 corresponds to a parent node with three children nodes depicted as the “Journal” icon 40, the “Calendar” icon 42, and the “Messages” icon 44, each having a distinct picture and title. The appearance of each icon 40, 42, 44 may be related to the title. A user may select by pointing and clicking the “Journal” icon 40 to access journal related information for John. Similarly, the “Calendar” icon 42 and “Messages” icon 44 may be used to access information related to John's calendar and messages, respectively.

The “Truck” icon 46 may be used to access data from a van cam 48 attached to a truck 50. The van cam 48 may provide a digital stream of video data 49, or an analog video signal. The data feed from the van cam 48 is associated in the program 11 with a “Truck” virtual object 48a. This virtual object 48a is represented as the “Truck” icon 46. A user may send commands to the van cam 48, such as, pan and zoom. Similarly, a security camera 52 is associated with a “Security Camera” virtual object 52a, and a “Security” icon 53 may be used to access the security camera video feed 55.

A virtual object, and its corresponding icon, may appear as a child for a plurality of parents. For example, as shown in FIG. 2, the nodes of the tree structure represented by the “Part Alpha” icons 32a, 32b, 32c may appear as the children for the “Machine A” icon 26, “Assembly A” icon 54, and “Assembly B” icon 56, respectively. The corresponding Part Alpha icon 32a for the real-world object Part Alpha 30 is displayed under “Machine A” icon 26 and “Assembly B” icon 56 because it may currently be assembled by Machine A 24, and Machine A may be part of assembly B. Also, the Part Alpha virtual object 30a corresponding to Part Alpha 30 may have previously passed through an assembly A and thus is displayed as a child of the “Assembly A” icon 54. A user may configure the “Part Alpha” icons 32a, 32b, 32c such that they display the same information when accessed, or the user may configure the associated virtual objects to display different information. For example, the “Part Alpha” node 32b may be configured to display information such as, the fabrication start time, the finish time, the duration to complete the part, and real-time status information while “Part Alpha” node/icon 32a node may be configured to provide all data from machine A in a single log.

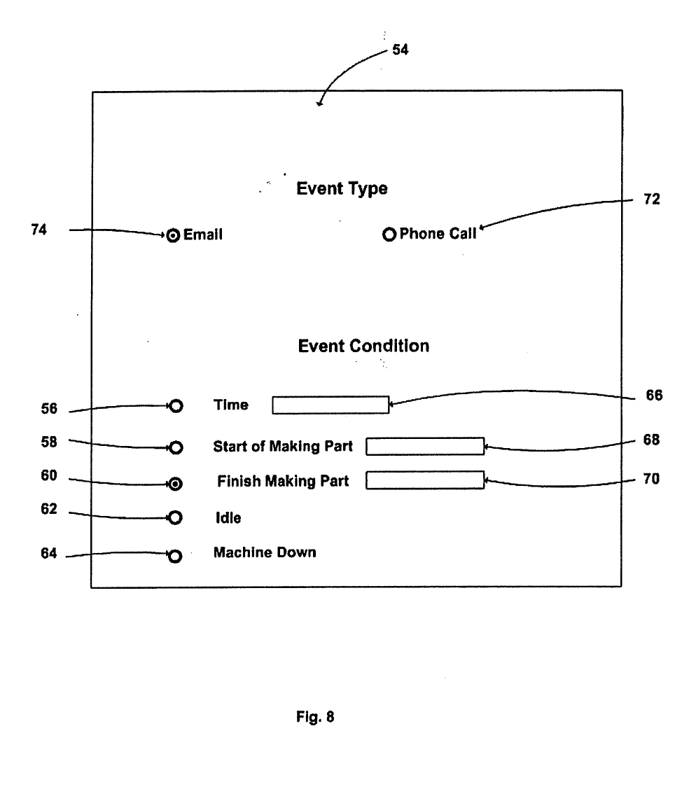

In one embodiment, a graphical user interface may be used to configure and generate event messages. Typically an event is triggered by the occurrence of a predetermined data value or values, from a single source or from multiple sources. Typically, the predetermined data value is a status data value of a real-world object. The event may be a regular or a reoccurring event, or may be a critical event that is expected to occur just once. Referring to FIG. 2, a user may configure an event message for machine A 24 by right-clicking on the “Machine A” icon 26 to access an event messaging menu 54 as shown in FIG. 8. The event messaging menu 54 allows a user to access information about the triggering condition using the buttons 56, 58, 60, 62, 64, and the select the type of event message to be received by authorized subscribers using the buttons 72, 74. In this example, a condition may comprise a preset time accessed using the button 56, the start of a part being made accessed using the button 58, the finish making of a part accessed using the button 60, the machine being idle accessed using the button 62, and/or the machine being inoperable accessed using the button 64. A user may designate a delay period before the event is generated to see if the condition for the event has changed status. A field 66 may be provided to enter the preset time 56. Fields 68, 70 may also be provided to allow the user to enter a specific part number to monitor for the “start of making part” accessed using the button 58 and/or the “finish making part” accessed using the button 60 conditions, respectively. The message types may comprise a phone call selected using button 72 and/or an email selected using button 74. A user may pre-write the email message as well as pre-record the phone call message.

HTS II

FIG. 7C depicts a node assignor 134 receiving data 132a from a real-world object 132 that has an associated virtual object. Referring also to FIG. 7D, the node assignor 134 samples, as depicted in step 133a, the data 132a to identify where the virtual object may be assigned as a child node. The node assignor 134 may, as depicted in step 133b, assign nodes by consulting a node placement table 136. The node assignor 134 then, as depicted in step 134a, sends a node assignment address to a data management system 138 where a virtual object relating to this data (and therefore real-world object 132) is, as depicted in step 133c, placed as a node in a hierarchical tree structure HTS II. A visual image of a hierarchical tree structure HTS II is generated as a graphical user interface 138a and/or web page for display on the screen 140. The node assignor 134 continuously evaluates the data 132a from the real-world object 132 to determine which node or nodes this data should be assigned to and changes nodes if necessary. A node assignor 134 may be part of the routed virtual object, may be part of the virtual object routed to, may be a component of a centralized router in the data management system 138, or one or more of these components.

FIGS. 6A and 7A are each area maps 114, 116, respectively, that indicate the position of police cars. The police cars may be tracked using a global positioning system. The maps 114, 116 illustrate a single region A, and region A is divided into districts A identified by the numeral 114a, B identified by the numeral 114b, C identified by the numeral 114c and D identified by the numeral 114d. FIG. 6A illustrates a first instance of time where car K identified by the numeral 118k is located in district A 114a, car L identified by the numeral 118l is in district B 114b, car M identified by the numeral 118m is in district C 114c, and car N identified by the numeral 118n is in district D 114d. FIG. 7 illustrates a second instance of time where car K 118k is located in district A 114a, car L 118l is in district B 114b, car M 118m is in district A 114a, and car N 118n is in district D 114d. There are no police cars in district C 114c.

FIGS. 6B and 7B are each graphic user interfaces 120, 122, displaying the information in the maps illustrated in FIGS. 6A and 6B, respectively. In FIG. 6B is the graphic user interface 120 represents the location of the police cars 118k, 118l, 118m, 118n in region A at the first instance of time shown in FIG. 6A. The graphic user interface 120 in FIG. 6B has a “Root” node 124 with a “Car Region A” child icon 126. The “Car Region A” icon 126 has four child nodes/icons 128a, 128b, 128c, 128d that represent car district A, car district B, car district C, and car district D, respectively. The “Car K” icon 130k is displayed as a child of the “Car District A” icon 128a because car K 118k is located in car district A 114a. Similarly, the “Car L” icon 130l is the child of the “Car District B” icon 128b, the “Car M” icon 130m is the child of the “Car District C” icon 128c and the “Car N” icon 130n is the child of the “Car District D” icon 128d.

In FIG. 7B the graphic user interface 122 represents the location of the police cars 118k, 118l, 118m, 118n in region A at the second instance of time shown in FIG. 7A. One police car, car M 118m has moved to district A 114a from district C 114c. Referring to FIG. 7B, the “Car K” 130k and “Car M” 130m nodes/icons are displayed as the children of the “Car District A” icon 128a. The “Car L” icon 130l is a child of the “Car District B” icon 128b, and the “Car N” icon 130n is a child of the “Car District D” icon 128d. The “Car District C” icon 128c does not have any children because there are no police cars in district C 114c.

HTS III

In one embodiment, an embodiment of this invention, the data management system 84, may automatically generate a virtual object. Referring to FIG. 9A, a machine B identified by the numeral 76 manufactures parts. This machine B 76 is represented in the program 11 by a virtual world object 78 that is displayed as an icon 80 in graphic user interface 82. The machine B 76 is currently idle, and the idle status is indicated in a field 86 next to the icon 80. Since machine B 76 is idle, it is not manufacturing a part, thus icon 80 has no children that would indicate a part being made. Referring to FIG. 9B, machine B 76 is no longer idle and is building part Beta 75. Machine B 76 is generating data regarding the construction of part Beta 75 to the data management system 84. The data management system 84 receives the data and constructs the “Part B” virtual world object 87 and displays an associated icon 88 as child node/icon of the “Machine B” icon in the visual display 82. The “Part Beta” virtual world object 87 and the icon 88 may also be automatically removed once part Beta 75 is complete.

HTS IV

In one embodiment, a virtual world object may obtain data from another virtual world object rather than from a real-world object. FIG. 10 illustrates the relationship between the real-world objects John 36 and Mary 142 and virtual world objects 36b, 142b corresponding to John's calendar and Mary's calendar, respectively. A graphic user interface 144 displays corresponding icons representing these virtual world objects in a hierarchical tree structure IV. John 36 is a person that produces data when he records his activities identified by the numeral 36c using the data management system 146. John 36 may record his activities 36c using a calendaring program. The data corresponding to John's activities 36c are associated with a “John's Calendar” virtual world object 36b and this virtual world object is represented by a “John's Calendar” icon 36d in the hierarchical tree structure IV displayed ion the screen 145. An authorized subscriber may access John's activities 36c by clicking on the “John's Calendar” icon 36d to bring up a data window (not shown). Similarly, Mary 142 records her activities 142c, and associates the activities data with the “Mary's Calendar” virtual world object 142b which is displayed as the “Mary's Calendar” icon 142c.

The “Department Calendar” virtual world object 150 may be accessed to view the activities 36c, 142c of both John 36 and Mary 142 through the “Department Calendar” icon 150c. The “Department Calendar” virtual world object 150 establishes a data channel with the “John's Calendar” 36b and the “Mary's Calendar” 142b virtual world object to obtain both John 36c and Mary's 142c activities. The data 36c, 142c from the “John's Calendar” 36b and the “Mary's Calendar” 142b virtual world objects, respectively, are then accessible through the “Department Calendar” icon 150c. The activities data 36c, 142c from the “John's Calendar” 36b and the “Mary's Calendar” 142b virtual world objects may be formatted by grouping the data from the “John's Calendar” virtual world object in a display window separately from the data from “Mary's Calendar” virtual world object. The activities 36c, 142c may also be formatted in a single display window, with the data from each virtual world object 36b, 142b organized by date and time.

HTS V

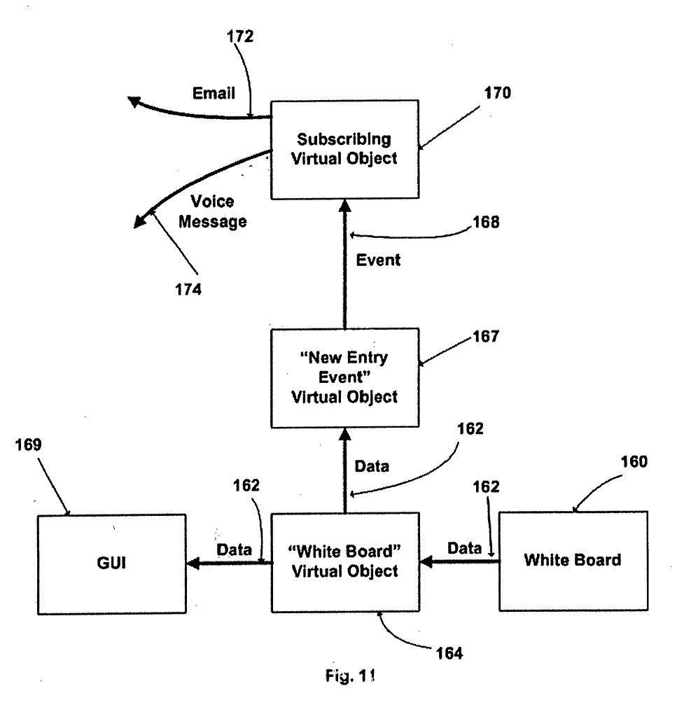

FIGS. 11 and 12 illustrate an embodiment where a virtual event object is used to configure and send event messages. Referring to FIG. 11, a white board 160 is a real-world object that transmits information written on the whiteboard as data 162 to a “white board” virtual world object 164. The data 162 is transmitted from the “white board” virtual world object 164 to a “new entry event” virtual world object 167, as well as a graphic user interface 169. The “new entry event” virtual world object samples the data 162 and generates an event 168 when the data equals a predetermined value. The predetermined value may be the white board 160 being turned off, which would indicate that a white board entry session has concluded. The event 168 is transmitted to a subscriber virtual world object 170, and this subscriber virtual world object sends an event message to a subscribing user typically through an email 172 and/or a phone call 174.

FIG. 12 illustrates a graphical user interface 180 that may be used to generate an event message for the white board in FIG. 11. The “Project B White Board” icon 182 is located in the hierarchical tree structure HTS V and represents a virtual world object for a white board used for a project entitled B. John, Ron and Jane are members of project B, and each has a virtual world object that are represented by icons entitled “John” 184, “Ron” 186, and “Jane” 188, respectively., The “Project B White Board” icon 182 as well as the “John” 184, “Ron” 186, and “Jane” 188 icons are displayed as children of the “Project B” icon 190.

As shown in FIG. 12A, a “New Entry event” icon 192 is, as depicted in step 193a, added and displayed as a child of the “Project B White Board” icon 182. The “New Entry event” icon 192 represents the “New Entry event” virtual world object 167 (FIG. 11). The “New Entry event” virtual world object 167 may be created using the “Project B White Board” icon 182. The event trigger, as depicted in step 193b, may be predetermined, or the user may determine what would be the triggering condition. A user may use the “New Entry event” icon 192 to access a menu (not shown) where he or she can subscribe, as depicted in step 193c, to event messaging to be notified when the “New Entry event” virtual object 167 is triggered. The “New Entry event” virtual world object 192 may identify an authorized subscriber through the user's access identity code. When the event trigger occurs, as depicted in step 193d, the subscribers of the “New Entry event” virtual object 167 are notified, as depicted in step 193e.

### SCOPE OF THE INVENTION

The above presents a description of the best mode contemplated of carrying out the present invention, and of the manner and process of making and using it, in such full, clear, concise, and exact terms as to enable any person skilled in the art to which it pertains to make and use this invention. This invention is, however, susceptible to modifications and alternate constructions from that discussed above which are fully equivalent. For example, the data management system 10 discussed above is merely illustrative and is not intended to be an exhaustive disclosure of all possible data management systems. The present invention may be implemented using a variety of technologies and computer systems, such as hardware utilizing either a combination of microprocessors or other specially designed application specific integrated circuits, programmable logic devices, or various combinations thereof. Consequently, it is not the intention to limit this invention to the particular embodiments disclosed. On the contrary, the intention is to cover all modifications and alternate constructions coming within the spirit and scope of the invention as generally expressed by the following claims, which particularly point out and distinctly claim the subject matter of the invention:

1. A machine-readable medium for programming a computer that is a component of a computer network, said medium including processor executable instructions for
(a) creating a user-definable hierarchical tree structure of virtual objects relating to one or more real-world objects including
(i) at least one user-definable virtual object relating to a change in status in a related real-world object, and
(ii) at least one user-definable virtual object that enables an authorized subscriber to access the hierarchical tree structure and communicate therewith to receive notification of a change in status in said real-world object,
(b) creating a browser control object that enables a user to interface with the hierarchical tree structure and communicate with said virtual objects, and
(c) creating a database capable of storing data relating to anyone of said virtual objects.

2. The machine-readable medium of claim 1 including a processor executable instruction for detecting the location in the hierarchical tree structure of any virtual object and changing the location in the tree structure of any one virtual object in response to notification of a change in status of a real word object related to said one virtual object.

3. The machine-readable medium of claim 1 including a processor executable instruction for interacting with a graphic user interface that enables the hierarchical tree structure to be displayed visually as an arrangement of parent and child nodes.

4. The machine-readable medium of claim 3 including a processor executable instruction for
(a) associating first status data with a virtual object to define the hierarchical relationship in the tree structure between one parent node and one child node based on said first data,
(b) associating second status data with said one child node and rearranging said one child node within the hierarchical tree structure under another parent node based on said second data.

5. The machine-readable medium of claim 4 including a processor executable instruction for storing said status data in said database.

6. The machine-readable medium of claim 3 including a processor executable instruction for identifying which of number of different human languages is being used by a human user and using said human language in visually displaying the hierarchical tree structure.

7. The machine-readable medium of claim 3 including a processor executable instruction for identifying which of number of different browser access devices is being used by a human user to interact with the hierarchical tree structure and to enable said browser control object to interface with the browser access device being used by the human user.

8. The machine-readable medium of claim 3 including a processor executable instruction for associating at least some of the nodes of the hierarchical tree structure with a web page that is opened through the browser control object interacting with a browser for the network.

9. The machine-readable medium of claim 3 including a processor executable instruction for
(a) interacting with more than one access device for accessing the hierarchical tree structure over the network,
(b) identifying the type of access device being used, and
(c) formatting the visual display of the hierarchical tree structure based on the type of access device being used.

10. A machine-readable medium for programming a computer that is a component of a computer network, said medium including processor executable instructions for
(a) creating a user-definable hierarchical tree structure of virtual world objects related to real-world objects,
(b) interacting with a graphic user interface that enables the hierarchical tree structure to be displayed visually as an arrangement of parent and child nodes,
(c) associating at least some of the nodes of the hierarchical tree structure with a web page that is opened through a browser control object interacting with a browser for the network,
(d) creating user-definable event virtual objects that provide notification when a change in status in a related real-world object occurs,
(e) creating each said virtual object to be capable of (i) detecting its location in the hierarchical tree structure, (ii) communicating with another virtual object, and (iii) changing its location in the hierarchical tree structure in response to notification of a change in status of its related real word object,
(f) creating user-definable subscriber virtual objects that provide authorized subscribers with access to the hierarchical tree structure and that communicate with the event virtual objects to enable said authorized subscribers to receive notification of a change in status in real-world objects,
(g) creating a browser control object that enables a user to interface with the hierarchical tree structure and communicate with said virtual objects, and
(h) creating a relational, open architecture database capable of storing data relating to the status of anyone of said real world objects in response to notification from an event virtual object.

11. The machine-readable medium of claim 10 including a processor executable instruction for
(a) associating first status data with an event virtual object to define the hierarchical relationship in the tree structure between one parent node and one child node based on said first data,
(b) associating second status data with said one child node and rearranging said one child node within the hierarchical tree structure under another parent node based on said second data.

12. The machine-readable medium of claim 10 including a processor executable instruction for identifying which of number of different human languages is being used by a human user and using said human language in visually displaying the hierarchical tree structure.

13. The machine-readable medium of claim 10 including a processor executable instruction for identifying which of number of different browser access devices is being used to interact with the hierarchical tree structure and for enabling said browser control object to interface with the browser access device being used.

14. The machine-readable medium of claim 10 including a processor executable instruction for
(a) interacting with more than one access device for accessing the hierarchical tree structure over the network,
(b) identifying the type of access device being used, and
(c) formatting the visual display of the tree structure based on the type of access device being used.

15. A machine-readable medium usable with a computer network for tracking real-world objects and including processor executable instructions for
(a) creating event virtual objects indicating at least two different states of each real world object,
(b) creating a database for storing information corresponding to the state of each real world object,
(e) creating a hierarchical tree structure of virtual objects related to the real-world objects that identifies relationships between the real-world objects,
(f) in response to one of the event virtual objects indicating a change in state of one of the real-world objects, changing in the tree structure the location of the virtual object related to said one real-world object to indicate said change in state,
(g) creating subscriber virtual objects identifying authorized subscribers that may access the tree structure, and
(e) creating a browser control object that enables a human user to communicate with the tree structure and said virtual objects.

16. The machine-readable medium of claim 15 wherein each virtual object relating to a real-world object is associated with a web page and the machine-readable medium includes a processor executable instruction for displaying the hierarchical tree structure on a display screen for viewing by a human user and allowing the human user to open and view on the screen the web page.

17. A machine-readable medium usable with a computer network for tracking real-world objects and including processor executable instructions for
(a) creating a user-definable event virtual objects indicating the status of each real world object,
(b) creating a database for storing information corresponding to the status of each real world object,
(e) creating a hierarchical tree structure of user-definable virtual objects related to the real-world objects that identifies the status of each real world object,
(f) in response to one of the event virtual objects indicating a new status of one of the real-world objects, updating the status information to indicate said new status of said one of the real-world object,
(g) creating user-definable subscriber virtual objects identifying authorized subscribers that may access the tree structure and who are notified of a new status of anyone of the real-world objects,
(h) displaying the tree structure on a display screen for viewing by a human user and allowing the human user to open and view on the screen the web page, and
(i) creating a browser control object that enables a human user to communicate with the tree structure and said virtual objects.

18. A machine-readable medium for programming a computer that is a component of a computer network, said medium including processor executable instructions for
(a) creating a user-definable hierarchical tree structure of virtual objects related to real-world objects that change in status, each virtual object indicating the status of its related real-world object and being accessible over the network,
(b) creating for the hierarchical tree structure a web page that may be opened and displayed visually upon being accessed,
(c) creating a browser control object that enables a user to interface with the hierarchical tree structure and communicate with said virtual world objects, and
(d) creating a database capable of storing information relating to the status of the real-world objects.

19. The machine-readable medium of claim 18 including a processor executable instruction for enabling each virtual object to be capable of communicating with another virtual object.

20. The machine-readable medium of claim 18 including a processor executable instruction for (i) creating user-definable event virtual objects that notify each virtual object of the tree structure of a change in status in a related real-world object, and (ii) creating user-definable subscriber virtual objects that enable authorized subscribers to access the tree structure and communicate therewith to receive notification of a change in status in real-world objects.

21. A machine-readable medium for programming a computer that is a component of a computer network, said medium including a processor executable instruction for enabling a user to access over the computer network a dynamic web page with hierarchically arranged icons relating to data representing information corresponding to the status of real world objects where the data is updated on line through the computer network.

22. The machine-readable medium of claim 21 including a processor executable instruction for enabling a user to create a hierarchical tree structure of virtual objects relating to said real world objects in a configuration of his or her choosing.

23. The machine-readable medium of claim 21 including a processor executable instruction for enabling a user to customize what events will update the data and who to notify when selected events occur and the manner in which notification is given.

24. The machine-readable medium of claim 21 including a processor executable instruction for enabling a user to create a web page that may be accessed in different languages and with a variety of different type of access devices.

25. A computer readable storage medium including program instructions for programming a computer that is, a component of a computer network, the program instructions comprising
providing accesses to a hierarchical tree structure including nodes representing one or more real-world object,
updating each said node with data indicating the current status of the real world object related to each said node, and
displaying said hierarchical tree structure as a web page on the computer network where said nodes are represented as interactive icons that upon being opened display the data associated with the current status of the related real world object.

26. A data management system comprising a computer network for tracking real world objects being monitored by a status monitor, said network being accessible with an access device operated by a user from a remote location and including a computer having a memory and processor, said processor being programmed
(i) to communicate with and store in the memory data corresponding to the status of each real world object, and
(ii) to provide virtual world objects relating to individual real world objects, said virtual world objects being organized in a hierarchical tree structure to be displayed visually as a web page comprising an arrangement of icons associated with said nodes, and
(iii) to enable a user to open said web page from a remote location using the access device.

27. The data management system of claim 26 where the processor is programmed to enable a plurality of authorized subscribers access the web page.

28. The data management system of claim 26 where the processor is programmed to enable the parent and child nodes to be rearranged as the status of any one of the real world objects changes.

29. The data management system of claim 26 where the processor is programmed to include a database in which the status of the real world objects is stored.

30. A computer implemented data management system for organizing data associated with real-world objects, comprising
a node assignor that associates each real world object with one of a plurality of nodes in a hierarchical tree structure,
an object engine that creates a virtual object for each node in the hierarchical tree structure and places each virtual object in said hierarchical tree structure,
a data receiver adapted to receive data from each real-world object and associate said data with the virtual object corresponding to each said real-world object, and
a graphical engine that associates an icon with each of said virtual objects and visually displays the hierarchical tree structure as an arrangement of said icons on a web page of a computer network.

31. A method for tracking over a computer network real-world objects that change status, comprising
(a) providing at a site on the network a hierarchical tree structure of virtual world objects related to the real-world objects,
(b) monitoring the status of each real-world object and communicating said status to its related virtual world object, and
(b) enabling the hierarchical tree structure to be accessed over the network and displayed visually to show the status of the real-world objects.

32. The method of claim 31 including enabling each virtual world object to be capable of communicating over the network with another virtual object.

33. The method of claim 31 including enabling a user to define the hierarchical tree structure as an arrangement of parent and child nodes that are displayed visually as icons upon the user opening the web page.

34. The method of claim 31 including (i) creating user-definable virtual event objects that notify each virtual world object of a change in status in a related real-world object, and (ii) creating user-definable virtual subscriber objects that enable authorized subscribers to access the tree structure and communicate with the virtual event objects to receive notification of a change in status in real-world objects.

35. A computer implemented method of displaying data relating to a real world object comprising:
providing a hierarchical tree structure including a plurality of parent nodes and at least one child node relating to a real world object,
associating a first data with said one child node and associating said child node with at least one of the parent nodes based on said first data,
associating a second data with said one child node and associating said child node with another parent node based on said second data, and
displaying said hierarchical tree structure on a web page provided on a computer network with said nodes being represented as interactive icons that upon being opened display the data associated with the opened icon.

36. A computer implemented method for organizing and displaying data in a hierarchical tree structure comprising
identifying at least one real world object,
providing an interface that interacts with said real world object to produce data relating to the status of said real world object, and
associating said data with nodes in a hierarchical tree structure and displaying said hierarchical tree structure on a web page of a computer network where said nodes are represented as interactive icons that upon being opened display the data associated with the opened icon.

37. A computer implemented method for generating an event signal via a computer network comprising
receiving data over said computer network from at least one real-world object where the value of the data varies over time,
associating said data with a node in a hierarchical tree structure including parent nodes and child nodes, said hierarchical tree structure only being accessible over said computer network by predetermined authorized subscribers,
establishing a predetermined data value of said data, and
generating an event signal when the varying value of the data attains said predetermined data value, and
sending said event signal over said computer network to the authorized predetermined subscribers.

38. A computer implemented method of managing and displaying data comprising:
providing a computer network that enables a user to accesses a hierarchical tree structure including nodes representing one or more real-world objects,
updating each of said node with data indicating the current status of the real world object related to each said node, and
displaying said hierarchical tree structure as a web page on the computer network where said nodes are represented as interactive icons that upon being opened display the data associated with the current status of the related real world object.
